(19) United States
(12) Patent Application Publication
(10) Pub. No.: US 2014/0280962 A1
(43) Pub. Date: Sep. 18, 2014

(54) METHOD AND SYSTEM FOR DELEGATING FUNCTIONALITY BASED ON AVAILABILITY

(71) Applicant: OpenPeak Inc., Boca Raton, FL (US)

(72) Inventor: Charles Peter Schultz, North Miami Beach, FL (US)

(21) Appl. No.: 13/927,451

(22) Filed: Jun. 26, 2013

Related U.S. Application Data
(60) Provisional application No. 61/793,991, filed on Mar. 15, 2013.

(51) Int. Cl. H04L 29/08

(52) U.S. Cl. CPC H04L 67/1074
USPC 709/226

(57) ABSTRACT

A method and system for delegating functionality in a delegate computing device is described herein. The delegate computing device may have access to first content while in a normal operation state. The method includes the steps of receiving a delegation notification and—in response to the receipt of the delegation notification—transitioning the delegate computing device from the normal operation state to a delegation state. While in the delegation state, the delegate computing device may have access to second content that is associated with a primary computing device. The method also includes the steps of receiving a cessation notification and—in response to the receipt of the cessation notification—transitioning the delegate computing device from the delegation state back to the normal operation state. While back in the normal operation state, the delegate computing device no longer has access to at least some portion of the second content.

### CROSS-REFERENCE TO RELATED APPLICATIONS

This patent application claims priority to U.S. Patent Application No. 61/793,991, filed on Mar. 15, 2013, which is herein incorporated by reference in its entirety.

### FIELD OF TECHNOLOGY

The present description relates to systems and methods for enabling users of computing devices to delegate assigned tasks to other users or computing devices based on availability.

### BACKGROUND

Many mobile communication devices have the ability to install and utilize applications that enable users to efficiently perform a variety of tasks. For example, an employee of a company may utilize a device configured with business applications to perform job related tasks. The applications to which the device has access, along with settings and privileges of the device, may be related to the role of the employee within the company, and to tasks for which the employee is responsible. As such, different devices utilized by different users within the company may have different functionality to perform job related tasks.

Situations may arise in which a user of a device is unavailable to perform an assigned task, for example, a task related to the operations of a company. It may be beneficial that another user, a delegate, assumes responsibility for performing the task. However, a device assigned to the delegate may not be equipped to perform the task under normal operating conditions, and may require configuration changes. For example, a required application may need to be installed on the delegate's device, or an existing application on the device may need a setting or privilege changed. As the performance of such tasks may be important to the operations of a company or a group, there is a need for delegating functionality based on availability.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system that is capable of supporting the delegation of functionality among computing devices.

FIG. 2 illustrates an example of a primary computing device.

FIG. 3 illustrates an example of a delegate computing device.

FIG. 4 illustrates an example of a method that can be used to delegate functionality among computing devices.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### SUMMARY

A method of delegating functionality in a delegate computing device that has access to first content in a normal operation state is described herein. The method can include the steps of receiving a delegation notification at the delegate computing device, and in response to the receipt of the delegation notification, transitioning the delegate computing device from the normal operation state to a delegation state. When in the delegation state, the delegate computing device may have access to second content, and the second content may include content that is associated with a primary computing device. The method can also include the steps of receiving a cessation notification at the delegate computing device, and in response to the receipt of the cessation notification, transitioning the delegate computing device from the delegation state back to the normal operation state such that the delegate computing device no longer has access to at least some portion of the second content.

The method can also include the step of performing a task on behalf of the primary computing device when the delegate computing device is in the delegation state. In one arrangement, the primary computing device may be assigned to a supervisor or a manager. In another arrangement, a privilege access level assigned to the delegate computing device in the delegation state may be more permissive in comparison to a privilege access level assigned to the delegate computing device when the delegate computing device is in the normal operation state.

The method can also include the step of determining a performance measurement of the delegate computing device during the time the delegate computing device had access to the second content. In one embodiment, if the performance measurement meets a predetermined threshold, the delegate computing device may be permitted to maintain access to at least some portion of the second content once the delegate computing device is transitioned from the delegation state back to the normal operation state. In another embodiment, the delegate computing device may not be permitted access to any of the second content when transitioned from the delegation state back to the normal operation state.

As an example, the delegation notification or cessation notification may be received in response to a setting of a status indicator. In another example, the delegation notification may identify a task that is to be delegated to the delegate computing device. As such, the task may be normally assigned to the primary computing device when the primary computing device is in a normal operation state.

In one arrangement, the delegate computing device can be pre-configured with a delegation task procedure, which may be followed in the method when the delegate computing device transitions from the normal operation state to the delegation state. In another arrangement, transitioning the delegate computing device between the delegation and normal operation states may include installing or uninstalling applications on the delegate computing device, adding or removing data from the delegate computing device, or modifying settings on the delegate computing device.

Another method of delegating functionality is also described herein. The method can include the steps of detecting an unavailability condition at a primary computing device, and in response to the detection of the unavailability condition, generating a delegation notification that indicates the unavailability condition of the primary computing device. In one arrangement, the primary computing device may have an assigned delegate computing device. In another arrangement, the delegation notification may enable the delegate computing device to have access to content that is associated with the primary computing device.

In one embodiment, the primary computing device may be assigned to a supervisor or a manager of a user of the delegate computing device. In another embodiment, the delegation notification may further enable the delegate computing device to perform a task on behalf of the primary computing device or may provide a more permissive privilege access level to the delegate computing device. In yet another embodiment, the delegation notification can identify a task that has been delegated to the delegate computing device. The task may be normally assigned to the primary computing device when the primary computing device is in a normal operation state.

The method may further include the steps of detecting an availability condition at the primary computing device, and in response to the detection of the availability condition, generating a cessation notification that indicates the availability condition of the primary computing device. In one embodiment, the cessation notification may revoke the access of the delegate computing device to the content that is associated with the primary computing device.

In an example, the unavailability condition or the availability condition may be based on a setting of a status indicator of the primary computing device. In another example, the setting of the status indicator can occur on an automatic basis or a manual basis.

A delegate computing device that has access to first content in a normal operation state is also described herein. The delegate computing device may include an interface that is configured to transmit and receive signals and a processing unit that is communicatively coupled to the interface. The processing unit may be configured to receive a delegation notification from the interface, and to transition the delegate computing device to a delegation state to enable access to second content that is associated with a primary computing device. The processing unit may be further configured to receive a cessation notification from the interface, and to transition the delegate computing device to the normal operation state. The transition to the normal operation state may revoke the access of the delegate computing device to at least some portion of the second content.

In one arrangement, the delegate computing device may be configured to perform a task on behalf of the primary computing device when the delegate computing device has been transitioned to the delegation state. In another arrangement, the delegate computing device can be configured to execute an application that is part of the second content as part of performing a task on behalf of the primary computing device when the delegate computing device has been transitioned to the delegation state. In yet another arrangement, the delegate computing device may be granted a more permissive privilege access level when in the delegation state, to enable the delegate computing device to access the second content associated with the primary computing device.

The delegate computing device may also include a memory unit that is communicatively coupled to the processing unit, and the memory unit may be configured to store a delegation task procedure that outlines one or more procedures for the delegate computing device to follow in the delegation state.

A primary computing device is also described herein. The primary computing device may include an interface that is configured to transmit and receive signals, and may further include a status indicator engine that is configured to detect an availability condition of the primary computing device. In one arrangement, the availability condition can indicate the availability of a user of the primary computing device.

The primary computing device may also include a processing unit that is communicatively coupled to the interface and to the status indicator engine, and the processing unit may be configured to receive an availability notification from the status indicator engine. The processing unit may also be configured to generate, in response to the reception of the availability notification, a delegation notification that enables a delegate computing device to have access to content that is associated with the primary computing device. In addition, the processing unit may be configured to send the delegation notification to the interface for transmission to the delegate computing device.

In one embodiment, the processing unit may be further configured to receive a second availability notification from the status indicator engine, and in response to the reception of the second availability notification, generate a cessation notification that disables the access of the delegate computing device to at least some of the content that is associated with the primary computing device. In another embodiment, the status indicator engine can be configured to receive schedule information from an application.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected (directly or indirectly) such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. A “network” is defined as a collection of hardware and software components that includes a managing entity and one or more users, wherein the managing entity and the users are communicatively coupled. The terms “computer program medium” and “computer readable medium” are defined as one or more components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “content” is defined as one or more applications, settings, configurations or policies that may be applied to a computing device. The term “privilege” is defined as a level of access, management, control or authority over content or other services associated with a computing device. The term “setting” is defined as a state or condition or some relation to a state or condition. The term “access” is defined as the right, ability or permission to perform some act or to obtain or receive data. For example, a computing device may have access to execute one or more applications of a set of content or has the authority to cause such execution as governed by the privileges associated with the applications.

The term “normal operation state” is defined as a state in which a computing device is granted access to and control of those features, functions, and/or content that would be available to the computing device during the normal course of business or activity of the computing device. The term “delegation state” is defined as a state in which a first computing device is granted access to and control of a set of features, functions, and/or content that would not otherwise be available in a normal operation state. Such a state may be applicable to a computing device that has been delegated the responsibility to perform a task on behalf of another computing device that would normally be performed by the user of the other device. The term “transition” is defined as movement, passage or change from one position or state to another.

The term “operating system” is defined as a collection of software components that directs a computing device's operations, including controlling and scheduling the execution of other programs and managing storage, input/output and communication resources. A “processing unit” is defined as one or more components that execute sets of instructions, and the components may be separate from one another or part of one whole unit and may even be located in different physical locations. The term “memory” or “memory element” is defined as one or more components that are configured to store data, either on a temporary or persistent basis. The term “database” is defined as a collection of data that may be organized in a manner that facilitates efficient access. An “interface” is defined as a component or a group of components that enable(s) a device to communicate with one or more different devices, whether through hard-wired connections, wireless connections or a combination of both. A “graphical display” is defined as a component or group of components that enable(s) a device to display items such as information, pictures, icons, or the like such that the items can be viewed or sensed by a person or a device. A “transceiver” is defined as a component or a group of components that transmit signals, receive signals or transmit and receive signals, whether wirelessly or through a hard-wired connection or both.

As explained earlier, a user may depend on a computing device for performing tasks, which may include job related tasks associated with a company that employs the user. In situations in which the user becomes unavailable or unable to perform those tasks, the company may still need the tasks performed as part of its normal business operations. Unfortunately, computing devices associated with other users, such as other employees of the company, may not be enabled to perform the tasks in normal situations.

A method and system for delegating functionality in a computing device is described herein to address this problem. In particular, at a delegate computing device that may have access to first content while in a normal operation state, a delegation notification can be received. In response to the receipt of the delegation notification, the delegate computing device can be transitioned from the normal operation state to a delegation state. While in the delegation state, the delegate computing device may have access to second content that is associated with a primary computing device. In addition, a cessation notification can be received at the delegate computing device. In response to the receipt of the cessation notification, the delegate computing device can be transitioned from the delegation state back to the normal operation state. While back in the normal operation state, the delegate computing device may no longer have access to at least some portion of the second content.

As such, the method and system provide a way for tasks normally assigned to the user of the primary computing device to be assigned to a delegate user in situations in which the user of the primary computing device becomes unavailable or unable to perform the tasks. The method and system also enable the delegate computing device to perform the tasks, as the delegate computing device may not be capable of performing the tasks under normal operating conditions. Such a feature can increase the efficiency of an organization, as tasks may be performed even when key individuals are unavailable.

Referring to FIG. 1, an example of a system 100 that supports delegating functionality between computing devices is shown. The system 100 may include a primary computing device 105 and one or more delegate computing devices 115, 120, 125. Although FIG. 1 shows a single primary computing device 105 and three delegate computing devices 115, 120, 125, it is understood that the system 100 is not limited to the example shown, and can actually support any suitable number of either type of computing device.

Referring to FIG. 2, a block diagram of an example of a primary computing device 105 is shown. A “primary computing device” is defined as a computing device that is configured to selectively delegate one or more tasks to another computing device or to selectively provide access to content by that computing device. The primary computing device 105 may include a processing unit 200, and may further include a memory unit 215, one or more inputs 220 and a keyboard 225, any or all of which may be communicatively coupled to the processing unit 200. The inputs 220 may include a mouse, a touch screen, a microphone, or any other suitable component that enables a user to provide input to the primary computing device 105. The primary computing device 105 may also include a graphical display 230, which may present a user with data, information, settings or the like, and may be communicatively coupled to the processing unit 200. The primary computing device 105 may also include an operating system and any suitable type of abstraction layers to enable applications that may be installed on the device 105 to interact with the components described here and other elements of the device 105. To enable the primary computing device 105 to communicate with other components, the device 105 may also include an interface 210. As an example, there may be multiple interfaces 210, each of which may be configured to support either wired or wireless communications with a variety of components, such as other computing devices, external networks, landline phones, desktop computers, or the like.

The primary computing device 105 may also include a status indicator engine 235, which may generate information about the availability of the primary computing device 105 of a user. The status indicator engine 235 may be communicatively coupled to the processing unit 200 or to the graphical display 230 (or both). The availability information may be generated internally by the status indicator engine 235 or may be received from applications like instant messaging, a calendar, or a social networking tool. In addition, one skilled in the art will appreciate that any suitable arrangement that provides the availability information can be used. The status indicator engine 235 may transmit the availability information to the graphical display 230 (directly or through the processing unit 200) to enable presentation to a user, for example, in an instant messaging display screen or some other user interface element. Furthermore, the status indicator engine 235 may also send the availability information to a back-end management unit 130 (see FIG. 1) for any purpose, including functions related to delegation of tasks. Additional description related to the back-end management unit 130 will be presented below. It should also be noted that the status indicator engine 235 may be a stand-alone component of the primary computing device 105 as shown in FIG. 2, but may also be a part of the processing unit 200.

Referring to FIG. 3, an example of a delegate computing device 115 is shown. A “delegate computing device” is defined as a computing device that is selectively assigned one or more tasks or selectively granted access to certain content by a primary computing device, such as when the primary computing device is unavailable. The delegate computing device 115 may include any or all (and any number) of the following components—a processing unit 300, an interface 310, a memory unit 315, one or more inputs 320, a keyboard 325, and a graphical display 330, any or all of which may be communicatively coupled to each other. Furthermore, such components as included in the delegate computing device 115 may be identical or similar to the counterpart components disclosed earlier for the primary computing device 105, in structure or in functionality. However, components included in the delegate computing device 115 should not be so limited, and any suitable components can be used. Like the primary computing device 105, the delegate computing device 115 may include an operating system and any suitable type of abstraction layers to enable applications that may be installed on the device 115 to interact with the components described here and other elements of the device 115.

The delegate computing device 115 may also include first content 340 or second content 360, which may be exclusive to each other, may include some common elements, or may be identical. That is, some or all of the elements included in the first content 340 may be included in the second content 360, and vice versa, although such overlap is not mandatory. In one arrangement, the delegate computing device 115 may have access to the first content 340 while in the normal operation state and may have access to the second content 360 while in the delegation state. The second content 360 is shown with a dashed outline as a reflection of this particular configuration; however, this arrangement is not meant to be limiting, and any suitable arrangement for access of the delegate computing device 115 to first content 340 or second content 360 is possible.

In one arrangement, the privileges 350, 370 may refer to the authority or capability of the delegate computing device 115 to execute, manage or otherwise operate the applications 345, 365 or some other content. As an example, a user in the role of network administrator may need access to applications on other computing devices, which may require what is commonly referred to as “administrative privileges.” As another example, a user of a delegate computing device 115 may need access to content that he/she may not necessarily have access to on a permanent basis. In one arrangement, the privileges 370 that are associated with the second content 360 may be higher, lower or even equal to the privileges 350 that are associated with the first content 340. For example, an access privilege to data may be more permissive in the privileges 370 than in the privileges 350, thus giving the delegate computing device 115 access to a greater range of data. The additional access may be prompted by the delegate computing device 115 being in the delegation state. As another example, the delegate computing device 115 may be provided with the ability to communicate across different communication networks or protocols (such as WiFi or 4G) while in the delegation state. The delegate computing device 115 may also be permitted to use a VPN or a different communications account, such as one that is with another wireless provider.

As an example, a setting may be some particular state or condition of one or more components of a computing device. For more specific (but non-limiting) examples, a setting may be the amount of wireless minutes assigned to a mobile unit, the amount of remote storage assigned to the mobile unit or the activation of features on the mobile unit that are normally deactivated or otherwise inoperable. One skilled in the art will appreciate that there are numerous other examples of settings that may be applicable here.

Referring back to FIG. 1, as referenced earlier, the system 100 may also include a back-end management unit 130, which may be configured to manage or oversee operations associated with the primary computing device 105, the delegate computing devices 115, 120, 125 and other suitable components. The back-end management unit 130 may include an interface 135 that enables communication with other components that may be internal or external to the system 100. The back-end management unit 130 may also include a database 155, which may store relevant data for the system 100 and for computing devices supported by the system. Examples of such data include a list of tasks performed by each computing device, a list of delegate candidates for each task, availability conditions of the computing devices, company organizational charts, or the like. Those skilled in the art will understand that any suitable implementation can be used for the database 155. For example, the database 155 can be a customized build, an “off the shelf” implementation that may comply with an industry standard, or a combination thereof. It should also be noted that the database 155 may be comprised of multiple components that work together to provide the required functionality, and some or all of those components may be located remotely from each other.

The back-end management unit 130 may further include a synchronization engine 140, a delegation engine 145, and a performance management engine 150, which may be communicatively coupled to each other or to the database 155. The synchronization engine 140 may perform synchronization functions such as keeping track of the availability of the primary computing device 105 and the availability of the candidate delegate computing devices 115, 120, 125. The delegation engine 145 may perform delegation functions, such as determining that a task needs to be delegated, the delegate(s) for the task, the delegation procedure, or the like.

The performance management engine 150 may perform functions related to evaluating the performance of users or computing devices as they perform tasks. As an example, when a delegate computing device 115 has performed a task delegated from a primary computing device 105, the performance management engine 150 may evaluate the performance of the delegate user during a time period and make a decision or recommendation that the delegate computing device 115 maintain partial or complete responsibility for performing the task, even after permissions or settings have been removed that were necessary for that performance to be executed. In one arrangement, the decision or suggestion can be based on a comparison of the delegate user's performance with a predetermined performance threshold. As another example, the performance management engine 150 may create or store rules, guidelines, thresholds, typical results, expected results, or the like for use in comparisons of performance. It should be noted that the synchronization engine 140, delegation engine 145, and performance management engine 150 can be distinct entities working together or can be wholly or partially combined.

Referring again back to FIG. 1, the system may also include a network 110, which may be comprised of any suitable combination of components that enables wireless or wired communications, or a combination thereof. The network 110 may be a single network, or may be comprised of multiple networks working together to perform networking tasks, as known to those skilled in the art. As shown in FIG. 1, the network 110 may be communicatively coupled to each of the primary computing device 105, the delegate computing devices 115, 120, 125, and the back-end management unit 130. The network 110 may also be enabled to communicate with entities outside of the system 100, such as external networks or desktop computers or the like. It should be further noted that, although not explicitly shown in FIG. 1, any of the components of the system 100 may also be communicatively coupled in a manner that does not utilize the network 110. As an example, the primary computing device 105 can be communicatively coupled to the delegate computing device 115 through an “off-network” or asynchronous connection. As another example, any of the computing devices (primary 105 or delegate 115, 120, 125) can be communicatively coupled to the back-end management unit 130 through a connection other than the network 110.

Referring to FIG. 4, a method 400 of delegating functionality among computing devices is shown. It is important to note that the method 400 may include additional or even fewer steps or processes in comparison to what is illustrated in FIG. 4. Moreover, the method 400 is not necessarily limited to the chronological order that is shown in FIG. 4. In describing the method 400, reference may be made to FIGS. 1-3, although it is understood that the method 400 may be practiced with any other suitable systems and components.

At step 405, an unavailability condition may be detected. In one embodiment, the unavailability condition may occur when a user of a computing device has become or is about to become incapable of performing an assigned task for any number of reasons. As an example, the unavailability condition may occur when the user has a scheduled event, such as a meeting or a vacation, which may be recorded in a program, such as an electronic calendar, an instant messaging tool, a social networking tool, or any other suitable program. The unavailability condition may be detected by the program using a status indicator or other information, such as an appointment notice embedded within an email message or another separate calendar or scheduling program. In another example, the user may manually change the status indicator to “busy” or “unavailable” or the like during a time period, and the unavailability condition may be detected in response. As another example, the unavailability condition may be detected after a period of non-use of the computing device, such as a predetermined amount of time over which no activity has been detected on the device. It should be further noted that the unavailability condition can be detected when the change in the status indicator occurs, after the change in the status indicator occurs, or at a previous time in response to a predicted future change in the status indicator.

Referring again to FIG. 1, in another example of the unavailability condition, a computing device assigned to the user, such as the primary computing device 105, can lose connectivity to the network 110, causing a loss of required access for performing the assigned task. Such a loss of connectivity can occur due to physical reasons related to the communication medium, such as the primary computing device 105 being outside the coverage area of the network 110. The term “coverage area” is commonly known to include physical locations within a certain distance of components of the network 110, such as base stations or access points or the like. Loss of connectivity can also occur due to the physical environment around the primary computing device 105 being affected by obstacles, such as vehicles or buildings, or by interference caused by transceivers on other electronic devices. In yet another example, the loss of connectivity can occur due to physical or electrical failure of the primary computing device 105 or any component of the network 110. Such a loss of connectivity and a resulting unavailability condition may be detected by the network 110, for example, if a base station within the network 110 is no longer able to receive signals from the primary computing device 105.

In another example of the unavailability condition, the location of a user may be within a jurisdiction or location in which performance of a task, such as running an application, is non-compliant with any law, policy, rule, or the like. For instance, a country may outlaw the use of mobile devices in government buildings or in vehicles, in which case the user may be considered unavailable to perform the task. It should be understood that the unavailability condition in this case may be determined before, during, or after the user is in such a location. In another example, the unavailability condition may occur as a result of loss or theft of the computing device or a report thereof, or the computing device may be out of service or reported to be out of service. In another example of unavailability, the computing device may have insufficient calling minutes or credits or the like.

The unavailability condition may also occur as a result of a violation of one or more device management policies. For instance, the detection of malware on the computing device or a determination that the computing device is “rooted,” may result in a violation of a device management policy, and in turn, an unavailability condition at the computing device. It should be noted that such a policy may be defined, created, or managed by any suitable component or components within or outside of the system 100. For instance, an anti-virus policy may be administered by the IT department of a company, by an outside entity, or a combination thereof. Furthermore, it should be noted that the unavailability condition may occur before, during, or after the policy violation occurs.

As yet another example of the unavailability condition, the user of the primary computing device 105 may be relieved of responsibility for performing the task for any reason, including a change in job responsibility, termination of the user's job or the user may be unwilling to perform the task. It should be understood that the unavailability condition and its detection are not meant to be limited to the examples presented here, and any suitable method of detection can be used. Furthermore, the examples are not limited to the primary computing device 105, and may also be applied to any computing device in the system 100, including the delegate computing devices 115, 120, 125. In any of these examples, it may be desired to have a delegate computing device 115, 120, 125 manage one or more tasks on behalf of the unavailable primary computing device 105 or to be given access to content associated with the primary computing device 105.

Referring back to FIG. 4, at step 410, a delegation notification may be generated, which may be associated with one or more tasks assigned to the user of a computing device, such as the primary computing device 105. The delegation notification may include a list of tasks to be delegated, the delegate(s) for each task, the delegation procedure for each task, a time schedule over which the delegation occurs, or any other relevant information. The delegation notification can also provide access instructions or other permissions to enable a delegate computing device to access certain content that it may otherwise not be entitled to. To accommodate this information, the delegation notification may be comprised of a single message or even multiple messages over a period of time. It should be noted that the delegation notification can be generated by the primary computing device 105, by the delegation engine 145 of the back-end management unit 130, by a combination of the two working together, or by any component or group of components within or outside of the system 100. In one example, the primary computing device 105 may generate the delegation notification based on information received from the delegation engine 145.

It should be noted that the delegation of responsibility for a task may involve combining or dividing tasks. As an example, a single task normally assigned to the user of the primary computing device 105 may involve both scheduling aspects and financial aspects. For purposes of delegation, the single task may be divided into a scheduling task and a financial task, with each delegated to a different user. As another example, multiple tasks normally assigned to the user of the primary computing device 105 may be combined into fewer tasks or even a single task for purposes of delegation.

While the delegate for a task may be a single person, such as a person that reports directly to the user of the primary computing device 105, the delegate may also be a group of persons, any of whom can perform the task. In another embodiment, the delegate can be a group of persons for which a set of rankings is also included. The set of rankings may indicate that responsibility should first be transferred to one or more persons ranked first in the set, and if none of those persons are available to perform the task, the responsibility should be transferred to another person or group of persons. As a further illustration within this embodiment, the use of rankings in association with a group of persons functioning as delegates may be utilized during a time period in which a relatively large number of employees of a company tend to take vacation, for instance, in the United States and other countries during the second half of December, when several holidays occur. While these examples illustrate possible embodiments of a delegate, they are not meant to be limiting, and the delegate can be any person or group of persons so designated.

Identification of the delegate for each task may be performed in any number of ways, including the use of a prepared list that can include a delegate for at least some of the tasks. The list may also be updated periodically to account for changes within a company, for instance, in the reporting structure of the company, policies of the company, the roles or responsibilities of different users, or the like. In one example, the list may be input to the delegation engine 145 or the primary computing device 105 by a network administrator or any appropriate individual. In another example, the list may be sent from the delegation engine 145 to the primary computing device 105. In another example, the list may be created automatically by the delegation engine 145, by the primary computing device 105 or by both working together. In yet another example, the identity of the delegate may be determined using information about the roles of the user of the primary computing device 105 and other users, or information about relationships between the users. This information may be retrieved from or derived from a social networking or social media tool, or from any other appropriate source. In yet another example, the identity of the delegate may be determined using an organizational chart of a company. For instance, a default delegate may be the supervisor or a direct report of the user. It should be noted that these examples are not meant to be limiting, as the delegate may be identified using any suitable method.

The delegation notification may also include a delegation procedure for each task that needs to be delegated. In one arrangement, the delegation procedure may provide information to the delegate computing device 115 on how to transition from the normal operation state to the delegation state. However, it should be noted that the delegation procedure may include steps that may be applicable not only to the delegate computing device 115, but also to the primary computing device 105 or to any component within or outside of the system 100. Also, the steps of the delegation procedure may be intended to occur while a computing device is in any state of operation, such as the normal operation state, delegation state, or any appropriate state. Furthermore, it may be intended that a step be performed during any time period. For example, the time period may be before, after or during a transition from the normal operation state and the delegation state, a process that will be explained below. In another example, the time period may be before, after or during a transition from the delegation state to the normal operation state (will also be explained below).

In one embodiment, the delegation procedure for the task can be a prepared list of steps that is input directly to the delegation engine 145 or to the primary computing device 105 by a network administrator or any other appropriate individual or component. In another embodiment, the delegation procedure can be sent from the delegation engine 145 to the primary computing device 105. The prepared list may also include content or instructions or permissions for enabling the delegate computing device 115 to access content during the delegation state. In addition, the list may be updated periodically to reflect the currently accessible content of the primary computing device 105 or the delegate computing device 115, for instance. In another example, the delegation engine 145 or the primary computing device 105 may derive the delegation procedure through use of a program, taking as inputs the content that should be accessible in order to perform the task and the content to which the delegate computing device 115 currently has access.

At step 415, the delegation notification may be received. In one embodiment, the reception can occur at the delegate computing device 115, but it should be understood that the method is not limited to this embodiment, and reception of the delegation notification may occur anywhere within or outside of the system 100.

At step 420, the delegate computing device 115 may be transitioned from the normal operation state to the delegation state. The transition may occur in response to a delegation procedure included in the delegation notification, or may occur in response to any other suitable event. In one arrangement, the delegate computing device 115 may have access to first content 340 while operating in a normal operation state, and may require access to second content 360 while operating in the delegation state. The transition may include steps to provide or enable access to the second content 360. For example, applications or data files may be installed on or uninstalled from the delegate computing device 115. As another example, a privilege associated with an existing application may be changed, for instance to a more permissive level, including what is commonly referred to in the art as “elevated privileges.” As another example, an existing version of an application may be replaced with a version that has more, less, or different functionality. For instance, the existing application may be a student version or trial version, and the replacement may be the standard or upgraded version. In another example, an application may be reconfigured or unlocked to grant access to the delegate computing device 115. In yet another example, the delegate computing device 115 may be granted access to additional memory, such as remote storage within or outside of the system 100.

Access to the second content 360 may be necessary to enable the delegate computing device 115 to carry out certain tasks or other procedures on behalf of the primary computing device 105. Even so, it must be noted that the delegate computing device 115 may also rely solely on first content 340, solely on second content 360, or on both first and second content 340, 360 to perform such tasks.

In another arrangement, the transition from the normal operation state to the delegation state may require not just installation of an application on the delegate computing device 115, but may further require that the application be uninstalled from another different computing device such as the primary computing device 105. For instance, a company might only have a single instance of the application, which may be due to licensing or other use restrictions. In yet another arrangement, the transition may include giving a temporary role to the delegate user, such as “acting manager,” which may be recognized throughout the system 100 for any purpose. For example, an indication of the role change may be reflected in graphical displays 230, 330 of computing devices throughout the network 110, with the username of the delegate appearing in italic font or bold face or the like. Alternatively, the title “acting manager” may be explicitly written next to the username.

In yet another arrangement, the performance of one or more steps normally involved in the transition to the delegation state may be precluded by a set of rules that supersedes the normal transition steps. As an example, if a manager has responsibility for approving travel requests of all of his/her direct reports and the responsibility would normally be delegated to one of those same direct reports (a delegate), a set of rules may automatically prevent the delegate from being granted permission to approve a travel request for himself/herself while in the delegation state, although that same approval would normally be performed by the manager. Such a scenario, and other similar scenarios, may be commonly considered “conflict of interest” scenarios. Additional contingency plans may be developed to account for conflict of interest scenarios, such as transferring the delegated task to another delegate who may be authorized to process the task.

Although the embodiments disclosed may serve to exemplify the transition to the delegation state, they are not meant to be limiting, and the method transition may be performed using any suitable process.

At step 425, a task may be performed on behalf of the primary computing device 105. In one embodiment, the task is performed by the delegate computing device 115 while in a delegation state, but the method is not limited to this embodiment, and the task may be performed by any device or component anywhere within or outside of the system 100. The task may involve the use of a program included in the applications 345, 365.

As an example task, the delegate computing device 115 may perform approval of a timesheet using an application that is included in the applications 365 but is not included in the applications 345. In another example of a task, the delegate computing device 115 may approve an expense report using an application in the applications 365. In yet another example, the delegate computing device 115 may be delegated responsibility for performing administrative functions throughout the system 100, such as adding or deleting applications to the computing devices of other users, adding or deleting accounts for other users, or modifying settings or privileges of applications accessible to other users.

In one arrangement, a delegate computing device 115, when it is in the delegation state, may have a sub-delegate computing device assigned to it. As such, if a delegate computing device 115 that is operating in a delegation state becomes unavailable, the tasks or settings/privileges associated with the delegation state may be applied to the sub-delegate computing device. In other words, the process of transferring duties, responsibilities, tasks or functions to a delegate device may be hierarchical in nature such that a serial transitional chain is created between numerous delegate devices and a primary computing device 105.

At step 430, an availability condition may be detected. The availability condition may be related to the expiration, cancellation, or non-occurrence of the unavailability condition with respect to the primary computing device 105 as disclosed earlier, but is not meant to be so limited. In one arrangement, the availability condition may occur anytime that a user or a computing device is available to perform a task, for example before or after a scheduled meeting. In another arrangement, the availability condition may be detected in response to a change in a status indicator of the primary computing device 105, for instance a change to the status “available” or the like. Such a change may be performed automatically or may be performed manually by a user, and it should also be noted that the availability condition can be detected when the change in the status indicator occurs, or after the change in the status indicator occurs, or may be detected at a previous time in response to a predicted future change in the status indicator. In yet another example, the availability condition may be detected from information not necessarily tied directly to a status indicator, such as an appointment embedded within an email message or another separate calendar or scheduling program.

For example, the availability condition may occur when a computing device, such as the primary computing device 105, is once again within the coverage area of the network 110. The availability condition may be detected before, during, or after the entrance into the coverage area. The availability condition may also be detected when a computing device regains connectivity after losing it. In another example, the availability condition may occur in response to the computing device partially or wholly correcting a violation of one or more device management policies. As previously described with respect to the unavailability condition, examples of policy violations include the presence of malware on the computing device or the computing device being rooted, but policy violations are not limited to these examples. Furthermore, it should be noted that the availability condition may occur before, during, or after the correction of the policy violation occurs. As an example, an anti-virus program may eliminate or neutralize malware from a computing device, resulting in an availability condition. As another example, the availability condition may occur before, during, or after the computing device enters a “conformance state,” which may be defined or evaluated by any person or component within the system 100, such as the back-end management unit 130.

These examples of the availability condition are not meant to be limiting, and detection of the availability condition may be accomplished by any suitable method. Moreover, the term “availability condition” is defined as a condition or state that provides an indication as to whether a user of a computing device or the computing device itself is available to perform tasks associated with or otherwise operate the computing device and may also refer generically to whether or not a user, computing device, or the like is available or unavailable.

At step 435, a cessation notification may be generated. The cessation notification may be generated in response to, for example, the user of the primary computing device 105 becoming available, as described above. The cessation notification may include items previously disclosed in the discussion on delegation notification, such as a list of tasks to be delegated, the delegate(s) for each task, the delegation procedure for each task, a time schedule over which the delegation occurs, or any other relevant information, although a one-to-one correspondence with the delegation notification is not mandatory. Also, the cessation notification may be generated independently of the delegation notification, may be included partly or wholly within the delegation notification, or may be generated with intention that it work in concert with the delegation notification. It should also be noted that the cessation notification can be generated by the primary computing device 105, by the delegation engine 145, by a combination of the two working together, or by any component within or outside of the system 100. In one embodiment, the primary computing device 105 may generate the cessation notification based on information received from the delegation engine 145.

In one example, the delegation notification may include a task and a delegation procedure for the delegate computing device 115, and the cessation notification may be generated simply to inform the delegate computing device 115 that it no longer has responsibility for the task. In another example, the cessation notification may be generated in response to an availability condition of the primary computing device 105 or the delegate computing device 115. For instance, if a task assigned to the primary computing device 105 has been delegated as a result of the primary computing device 105 leaving the coverage area of the network 110, the cessation notification may be generated in response to the primary computing device 105 re-entering the coverage area. In another example, the cessation notification may be generated in response to a manual override from a user, such as a supervisor.

At step 440, the cessation notification may be received. In one embodiment, the reception can occur at the delegate computing device 115, but it should be understood that the method is not limited to this embodiment, and reception of the cessation notification may occur anywhere within or outside of the system 100.

At step 445, the delegate computing device 115 may be transitioned from the delegation state back to the normal operation state. In one arrangement, the transition may be performed by reversing the actions performed during transition from the normal operation state to the delegation state (step 420). For example, an application or data file installed during the transition to the delegation state may be uninstalled as part of the transition back to the normal operation state. As another example, a privilege level may be restored to the original level when the delegate computing device 115 was in the normal operation state. It should be noted, however, that the method 400 is not limited to these examples, and any steps that result in the computing device being returned to the normal operation state may be used.

In another embodiment, a user of the delegate computing device 115 or another user may be prompted to remove or alter data associated with the delegation state as part of the transition back to the normal operation state. As an example, the data that may have been transferred to the delegate computing device 115 may include records, “cookies” (as commonly known in the art), URLs, “bookmarks” (as commonly known in the art), or other information. Alternately, the data may be automatically removed or wiped from the delegate computing device 115. The removal may be performed by a function associated with the delegation state or by a function associated with the normal operation state or any other function.

Although transitioning back to the normal operation state may result in the delegate computing device 115 being in a state identical to the condition it was in before the delegation occurred, the description here is not so limited. For example, some or all of the modifications that were made during the transition to the delegation state (step 420), such as the installation of an application or data file, or a change in a privilege, may be optionally kept in place. In addition, as part of the transition back to the normal operation state, a list of actions that have occurred during the delegation process may be received by a user, such as a supervisor. Before, during, or after the transition back to the normal operation state, an option to allow the transition or to abort the transition may be presented to a user of the primary computing device 105, a user of the delegate computing device 115, or to both computing devices.

At step 450, a performance measurement of the delegate computing device 115 may be determined. The measurement can be related to the performance of one or more delegated tasks, performance of job-related tasks in general or any other suitable performance criterion. In one arrangement, these measurements can be used to determine whether a delegate has performed well enough to maintain access to certain tasks or data during the normal operation state, as opposed to removing this access once the delegate returns to the normal operation state. As an example, the number of times or percentage of time that the delegate user performed a delegated task correctly, the number of errors committed, the severity of the errors committed, the required time to perform the task or any other suitable measurement can be collected, stored, or used. The performance measurement can be determined at the performance management engine 150, elsewhere within the backend management unit 130, at the primary computing device 105, or at any suitable component within or outside of the system 100. In one example, individual performance measurements can be taken at the primary computing device 105 and forwarded to the performance management engine 150 for collection and analysis. It should be noted, however, that any suitable method of determining a performance measurement can be used.

At step 455, the performance measurement can be compared with a predetermined threshold. The comparison can be performed at the performance management engine 150, elsewhere within the back-end management unit 130, at the primary computing device 105, or at any suitable component within or outside of the system 100. In one example, the threshold may be stored in memory within the performance management engine 150 or the database 155. In another example, the threshold can be computed real-time by the performance management engine 150.

At step 460, in response to an affirmative comparison in step 455, the delegate computing device 115 may be permitted to maintain access to at least some portion of content to which it was given access in order to perform one or more delegated tasks. As an example, if the delegate user has performed the delegated tasks well, it may be desired that the user continue performing some of the delegated tasks, which may require continued access to some or all of the content. At step 465, the delegate user's access to the content may be removed in response to a negative comparison in step 455. As an example, the delegate user may have performed poorly or not well enough during a delegation period, and may be relieved of responsibility for performing the delegated tasks. As such, the delegate user may no longer need access to any of the content.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

1. A method of delegating functionality in a delegate computing device that has access to first content in a normal operation state, comprising:
receiving a delegation notification at the delegate computing device;
in response to the receipt of the delegation notification, transitioning the delegate computing device from the normal operation state to a delegation state, wherein when in the delegation state, the delegate computing device has access to second content and the second content includes content that is associated with a primary computing device;
receiving a cessation notification at the delegate computing device; and
in response to the receipt of the cessation notification, transitioning the delegate computing device from the delegation state back to the normal operation state such that the delegate computing device no longer has access to at least some portion of the second content.

2. The method according to claim 1, wherein the primary computing device is assigned to a supervisor or a manager.

3. The method according to claim 1, further comprising performing a task on behalf of the primary computing device when the delegate computing device is in the delegation state.

4. The method according to claim 1, wherein a privilege access level assigned to the delegate computing device in the delegation state is more permissive in comparison to a privilege access level assigned to the delegate computing device when the delegate computing device is in the normal operation state.

5. The method according to claim 1, further comprising:
determining a performance measurement of the delegate computing device during the time the delegate computing device had access to the second content; and
if the performance measurement meets a predetermined threshold, permitting the delegate computing device to maintain access to at least some portion of the second content once the delegate computing device is transitioned from the delegation state back to the normal operation state.

6. The method according to claim 1, wherein when the delegate computing device is transitioned from the delegation state back to the normal operation state, the delegate computing device is not permitted access to any of the second content.

7. The method according to claim 1, wherein the delegation notification or cessation notification is received in response to a setting of a status indicator.

8. The method according to claim 1, wherein the delegation notification identifies a task that is to be delegated to the delegate computing device, and the task is normally assigned to the primary computing device when the primary computing device is in a normal operation state.

9. The method according to claim 1, wherein the delegate computing device is pre-configured with a delegation task procedure and the method further comprises following the delegation task procedure when the delegate computing device transitions from the normal operation state to the delegation state.

10. The method according to claim 1, wherein transitioning the delegate computing device between the delegation and normal operation states includes installing or uninstalling applications on the delegate computing device, adding or removing data from the delegate computing device, or modifying settings on the delegate computing device.

11. A method of delegating functionality, comprising:
detecting an unavailability condition at a primary computing device, wherein the primary computing device has an assigned delegate computing device;
in response to detecting the unavailability condition, generating a delegation notification that indicates the unavailability condition of the primary computing device;
wherein the delegation notification enables the delegate computing device to have access to content that is associated with the primary computing device.

12. The method according to claim 11, wherein the primary computing device is assigned to a supervisor or a manager of a user of the delegate computing device.

13. The method according to claim 11, wherein the delegation notification further enables the delegate computing device to perform a task on behalf of the primary computing device or provides a more permissive privilege access level to the delegate computing device.

14. The method according to claim 11, wherein the delegation notification identifies a task that has been delegated to the delegate computing device, and the task is normally assigned to the primary computing device when the primary computing device is in a normal operation state.

15. The method according to claim 11, further comprising:
detecting an availability condition at the primary computing device; and
in response to detecting the availability condition, generating a cessation notification that indicates the availability condition of the primary computing device;
wherein the cessation notification revokes the access of the delegate computing device to the content that is associated with the primary computing device.

16. The method according to claim 15, wherein the unavailability condition or the availability condition are based on a setting of a status indicator of the primary computing device.

17. A delegate computing device that has access to first content in a normal operation state, comprising:
an interface that is configured to transmit and receive signals; and
a processing unit that is communicatively coupled to the interface, wherein the processing unit is configured to:
receive a delegation notification from the interface;
transition the delegate computing device to a delegation state to enable access to second content that is associated with a primary computing device;
receive a cessation notification from the interface;
transition the delegate computing device to the normal operation state, thereby revoking the access of the delegate computing device to at least some portion of the second content.

18. The delegate computing device according to claim 17, wherein the delegate computing device is configured to perform a task on behalf of the primary computing device when the delegate computing device has been transitioned to the delegation state.

19. The delegate computing device according to claim 18, wherein the delegate computing device is configured to execute an application that is part of the second content as part of performing a task on behalf of the primary computing device when the delegate computing device has been transitioned to the delegation state.

20. The delegate computing device according to claim 17, wherein when the delegate computing device is in the delegation state, the delegate computing device is granted a more permissive privilege access level to enable the delegate computing device to access the second content associated with the primary computing device.
